(19) United States
(12) Patent Application Publication
(10) Pub. No.: US 2019/0287331 A1
(43) Pub. Date: Sep. 19, 2019

(54) ELECTRONIC APPARATUS AND OPERATING METHOD THEREOF

(71) Applicant: Samsung Electronics Co., Ltd., Suwon-si (KR)

(72) Inventors: Sunghyuk LEE, Suwon-si (KR); Yongseok PARK, Suwon-si (KR); Hyojin JUNG, Suwon-si (KR)

(21) Appl. No.: 16/355,402

(22) Filed: Mar. 15, 2019

(30) Foreign Application Priority Data
Mar. 15, 2018 (KR) 10-2018-0030405

(51) Int. Cl. G07C 9/00; H04W 12/06; H04W 12/04; G06Q 20/40

(52) U.S. Cl. CPC G07C 9/00563; H04W 12/0608; G06Q 20/4012; H04W 12/04031; H04W 12/0401

(57) ABSTRACT

An electronic apparatus and an operating method thereof according to various embodiments may: transmit reference information, detected from a first external device, to a second external device; receive first password information, generated on the basis of the reference information, from the second external device; and provide the first password information to the first external device so that the first external device controls a locking device on the basis of the first password information.

### CROSS-REFERENCE TO RELATED APPLICATION

This application is based on and claims priority under 35 U.S.C. § 119 to Korean Patent Application No. 10-2018-0030405, filed on Mar. 15, 2018, in the Korean Intellectual Property Office, the disclosure of which is incorporated by reference herein in its entirety.

### BACKGROUND

### 1. Field

Various embodiments relate to an electronic apparatus and an operating method thereof.

### 2. Description of Related Art

The above information is presented as background information only to assist with an understanding of the disclosure. No determination has been made, and no assertion is made, as to whether any of the above might be applicable as prior art with regard to the disclosure.

With technological advancement, unattended systems are being introduced in various fields. In an unattended system, an electronic device is installed at a designated place and provides unattended services, such as access to a designated place, storage of goods, or sale of products. The electronic device authenticates a user and determines whether to provide a service to the user. For example, the electronic device can authenticate the user on the basis of biometric information about the user. When the user authentication is successful, the electronic device can provide the unattended service.

However, in order for the electronic device to authenticate the user, the biometric information about the user needs to be registered in advance. For example, the electronic device needs to store the biometric information about the user in advance. Alternatively, a server needs to store the biometric information about the user in advance, and the electronic device needs to communicate with the server to obtain the biometric information stored in advance. Then, the electronic device compares the biometric information stored in advance with biometric information input from the user, thereby authenticating the user.

### SUMMARY

As described above, in order for a user to use an unattended service via an electronic device, it is necessary to register biometric information about the user in advance, which is inconvenient. Here, when a server stores the biometric information about the user, the user of the electronic device may fail to use the unattended service. That is, when failure occurs in a network between the electronic device and the server, the user of the electronic device cannot use the unattended service. In addition, there is the risk that the biometric information about the user may be leaked from the electronic device or the server.

An electronic apparatus according to various embodiments may include: a communication module; a display device; at least one processor operatively connected to the communication module and the display device; and a memory operatively connected to the processor.

According to various embodiments, the memory may store instructions that, when executed, enable the processor to: transmit reference information, detected from a first external device, to a second external device through the communication module; receive first password information, generated on the basis of the reference information, from the second external device through the communication module; and provide the first password information to the first external device through the communication module so that the first external device controls a locking device on the basis of the first password information.

An operating method of an electronic apparatus according to various embodiments may include: an operation of transmitting reference information, detected from a first external device, to a second external device; an operation of receiving first password information, generated on the basis of the reference information, from the second external device; and an operation of providing the first password information to the first external device so that the first external device controls a locking device on the basis of the first password information.

According to various embodiments, a non-transitory computer-readable storage medium may store one or more programs to implement: an operation of transmitting reference information, detected from a first external device, to a second external device; an operation of receiving first password information, generated on the basis of the reference information, from the second external device; and an operation of providing the first password information to the first external device so that the first external device controls a locking device on the basis of the first password information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of an electronic apparatus in a network environment according to various embodiments;

FIG. 2 illustrates a block diagram of a system according to various embodiments;

FIG. 3 illustrates the flow of signals in a system according to various embodiments;

FIG. 4 illustrates a flowchart of an operating method of an electronic apparatus according to various embodiments;

FIG. 5 illustrates a flowchart of an embodiment of a reference information transmission operation in FIG. 4;

FIG. 6A illustrates a graphical user interface displayed when the embodiment of the reference information transmission operation in FIG. 4 is performed;

FIG. 6B illustrates a graphical user interface displayed when the embodiment of the reference information transmission operation in FIG. 4 is performed;

FIG. 7A illustrates a flowchart of various embodiments of a first password information transmission operation in FIG. 4;

FIG. 7B illustrates a flowchart of various embodiments of a first password information transmission operation in FIG. 4;

FIG. 7C illustrates a flowchart of various embodiments of a first password information transmission operation in FIG. 4;

FIG. 8A illustrates a graphical user interface displayed when the various embodiments of the first password information transmission operation in FIG. 4 are performed;

FIG. 8B illustrates a graphical user interface displayed when the various embodiments of the first password information transmission operation in FIG. 4 are performed;

FIG. 8C illustrates a graphical user interface displayed when the various embodiments of the first password information transmission operation in FIG. 4 are performed;

FIG. 8D illustrates a graphical user interface displayed when the various embodiments of the first password information transmission operation in FIG. 4 are performed;

FIG. 9 illustrates a flowchart of an operating method of a first external device according to various embodiments; and

FIG. 10 illustrates a flowchart of an operating method of a second external device according to various embodiments.

### DETAILED DESCRIPTION

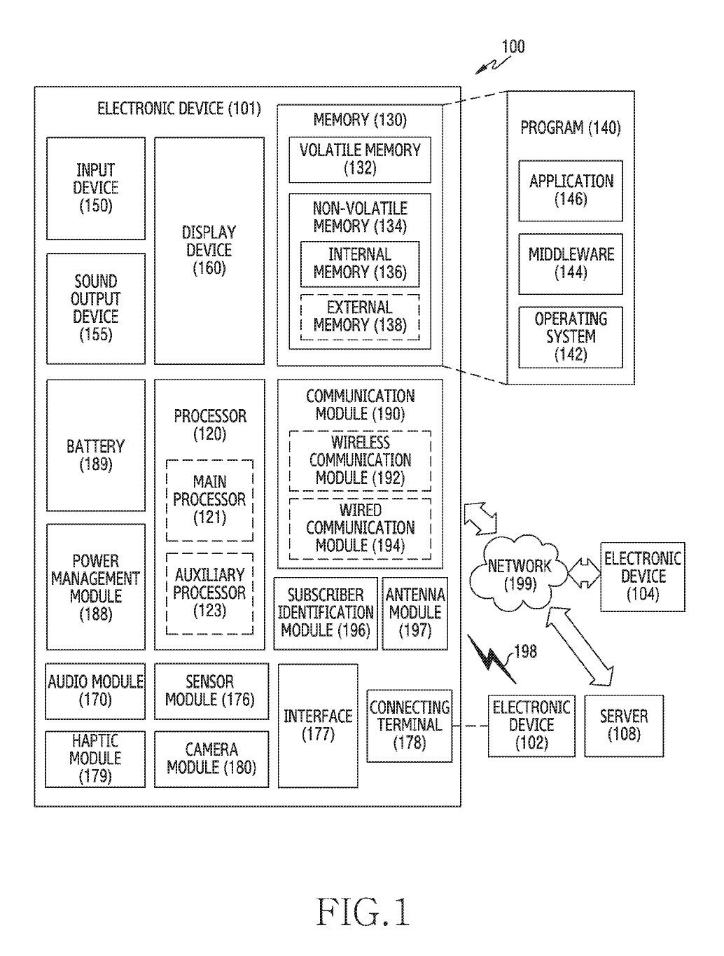

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of this document will be described with reference to the accompanying drawings.

FIG. 1 illustrates a block diagram of an electronic apparatus 101 in a network environment 100 according to various embodiments.

Referring to FIG. 1, in the network environment 100, the electronic apparatus 101 may communicate with an electronic apparatus 102 via a first network 198 (e.g., a short-range wireless communication network) or may communicate with an electronic apparatus 104 or a server 108 via a second network 199 (e.g., a long-range wireless communication network). According to one embodiment, the electronic apparatus 101 may communicate with the electronic apparatus 104 via the server 108. According to one embodiment, the electronic apparatus 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identity module 196, or an antenna module 197. In some embodiments, at least one (e.g., the display device 160 or the camera module 180) of these components may be omitted, or one or more other components may be further included in the electronic apparatus 101. In some embodiments, some of these components may be configured as an integrated circuit. For example, the sensor module 176 (e.g., a fingerprint sensor, an iris sensor, or an illumination sensor) may be embedded in the display device 160 (e.g., a display).

The processor 120 may run, for example, software (e.g., a program 140) to control at least one other component (e.g., a hardware or software component) of the electronic apparatus 101 connected to the processor 120, and may perform various types of data processing or arithmetic operations. According to one embodiment, as at least part of the data processing or operations, the processor 120 may load a command or data received from another component (e.g., the sensor module 176 or the communication module 190) into a volatile memory 132, may process the command or data stored in the volatile memory 132, and may store the resulting data in a nonvolatile memory 134. According to one embodiment, the processor 120 may include a main processor 121 (e.g., a central processing unit or an application processor) and a coprocessor 123 (e.g., a graphics processing unit, an image signal processor, a sensor hub processor, or a communications processor) that is operable independently of or together with the main processor 121. Additionally or alternatively, the coprocessor 123 may be configured to use lower power than the main processor 121 or to specialize in a designated function. The coprocessor 123 may operate separately from the main processor 121 or as a part thereof.

The coprocessor 123 may control at least some of the functions or states associated with at least one component (e.g., the display device 160, the sensor module 176, or the communication module 190) among the components of the electronic apparatus 101, for example, instead of the main processor 121 when the main processor 121 is in an inactive (e.g., sleep) state, or along with the main processor 121 when the main processor 121 is in an active (e.g., application-running) state. According to one embodiment, the coprocessor 123 (e.g., an image signal processor or a communications processor) may be configured as a part of another functionally related component (e.g., the camera module 180 or the communication module 190).

The memory 130 may store various data used by at least one component (e.g., the processor 120 or the sensor module 176) of the electronic apparatus 101. The data may include, for example, software (e.g., the program 140), and input data or output data about a command associated with the software. The memory 130 may include a volatile memory 132 or a nonvolatile memory 134.

The program 140 may be stored as software in the memory 130 and may include, for example, an operating system 142, middleware 144, or an application 146.

The input device 150 may receive a command or data to be used for a component (e.g., the processor 120) of the electronic apparatus 101 from the outside (e.g., a user) of the electronic apparatus 101. The input device 150 may include, for example, a microphone, a mouse, or a keyboard.

The sound output device 155 may output a sound signal to the outside of the electronic apparatus 101. The sound output device 155 may include, for example, a speaker or a receiver. The speaker may be employed for general use, such as for multimedia playback or recording playback, and the receiver may be used for receiving an incoming call. According to one embodiment, the receiver may be configured separately from the speaker or as a part of the speaker.

The display device 160 may visually provide information to the outside (e.g., a user) of the electronic apparatus 101. The display device 160 may include, for example, a display, a hologram device, or a projector and a control circuit for controlling a corresponding device. According to one embodiment, the display device 160 may include touch circuitry configured to detect a touch or sensor circuitry (e.g., a pressure sensor) configured to measure the strength of force generated by a touch.

The audio module 170 may convert a sound into an electrical signal, or, conversely, an electrical signal into a sound. According to one embodiment, the audio module 170 may acquire a sound through the input device 150 or may output a sound through the audio output device 155 or an external electronic apparatus (e.g., the electronic apparatus 102 (e.g., a speaker or a headphone)) connected directly or wirelessly to the electronic apparatus 101.

The sensor module 176 may detect an operating state (e.g., power or temperature) of the electronic apparatus 101 or an external environmental condition (e.g., a user's condition) and may generate an electrical signal or a data value corresponding to the detected state or condition. According to one embodiment, the sensor module 176 may include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The interface 177 may support one or more designated protocols that can be used for the electronic apparatus 101 to be directly or wirelessly connected to an external electronic apparatus (e.g., the electronic apparatus 102). According to one embodiment, the interface 177 may include, for example, a High-Definition Multimedia Interface (HDMI), a Universal Serial Bus (USB) interface, an SD card interface, or an audio interface.

A connection terminal 178 may include a connector through which the electronic apparatus 101 can be physically connected to an external electronic apparatus (e.g., the electronic apparatus 102). According to one embodiment, the connection terminal 178 may include, for example, as an HDMI connector, a USB connector, an SD card connector, or an audio connector (e.g., a headphone connector).

The haptic module 179 may convert an electrical signal into a mechanical stimulus (e.g., vibrations or a movement) or an electrical stimulus that is perceivable by the user through a tactile sensation or the sense of movement. According to one embodiment, the haptic module 179 may include, for example, a motor, a piezoelectric element, or an electrical stimulation device.

The camera module 180 may capture a still image and a moving image. According to one embodiment, the camera module 180 may include one or more lenses, image sensors, image signal processors, or flashes.

The power management module 188 may manage the power supplied to the electronic apparatus 101. According to one embodiment, the power management module 188 may be configured, for example, as at least a part of a Power Management Integrated Circuit (PMIC).

The battery 189 may supply power to at least one component of the electronic apparatus 101. According to one embodiment, the battery 189 may include, for example, a non-rechargeable primary battery, a rechargeable secondary battery, or a fuel cell.

The communication module 190 may support establishing a direct (e.g., wired) communication channel or a wireless communication channel between the electronic apparatus 101 and an external electronic apparatus (e.g., the electronic apparatus 102, the electronic apparatus 104, or the server 108) and performing communication through the established communication channel. The communication module 190 may include one or more communication processors that operate independently of the processor 120 (e.g., an application processor) and support direct (e.g., wired) communication or wireless communication. According to one embodiment, the communication module 190 may include a wireless communication module 192 (e.g., a cellular communication module, a short-range wireless communication module, or a Global Navigation Satellite System (GNSS) communication module) or a wired communication module 194 (e.g., a Local Area Network (LAN) communication module or a power-line communication module). Among these communication modules, a corresponding communication module may communicate with an external electronic apparatus via the first network 198 (e.g., a short-range wireless communication network including a Bluetooth, Wi-Fi direct, or Infrared Data Association (IrDA) network) or the second network 199 (e.g., a long-range wireless communication network including a cellular network, the Internet, or a computer network (e.g., a LAN or WAN)). These various types of communication modules may be integrated into one component (e.g., a single chip) or may be configured as a plurality of separate components (e.g., a plurality of chips). The wireless communication module 192 may identify and authenticate the electronic apparatus 101 within a communication network, such as the first network 198 or the second network 199, using subscriber information (e.g., an International Mobile Subscriber Identity (IMSI)) stored in the subscriber identity module 196.

The antenna module 197 may transmit a signal or power to the outside (e.g., an external electronic apparatus) or may receive a signal or power from the outside. According to one embodiment, the antenna module 197 may include one or more antennas, among which at least one antenna suitable for a communication mode used for a communication network, such as the first network 198 or the second network 199, may be selected, for example, by the communication module 190. A signal or power may be transmitted or received between the communication module 190 and an external electronic apparatus via the at least one selected antenna.

At least some of the components may be connected to each other via a communication mode between peripheral devices (e.g., a bus, General-Purpose Input and Output (GPIO), Serial Peripheral Interface (SPI), or Mobile Industry Processor Interface (MIPI)) and may exchange signals (e.g., a command or data) with each other.

According to one embodiment, a command or data may be transmitted or received between the electronic apparatus 101 and the external electronic apparatus 104 via the server 108 connected to the second network 199. Each of the electronic apparatuses 102 and 104 may be a device of the same kind or a different kind from the electronic apparatus 101. According to one embodiment, all or some operations performed by the electronic apparatus 101 may be performed by one or more external electronic apparatuses among the external electronic apparatuses 102, 104, or 108. For example, when the electronic apparatus 101 needs to perform a function or a service automatically or upon request from a user or another device, the electronic apparatus 101 may, instead of or in addition to autonomously executing the function or the service, request at least one or more external electronic apparatuses to perform at least part of the function or the service. Upon receiving such a request, the one or more external electronic apparatuses may execute the at least part of the requested function or service or an additional function or service associated with the request, and may transmit the result of execution thereof to the electronic apparatus 101. The electronic apparatus 101 may provide the result, as at least part of a response to the request, without any processing or via additional processing. To this end, for example, cloud-computing, distributed-computing, or client-server-computing technologies may be used.

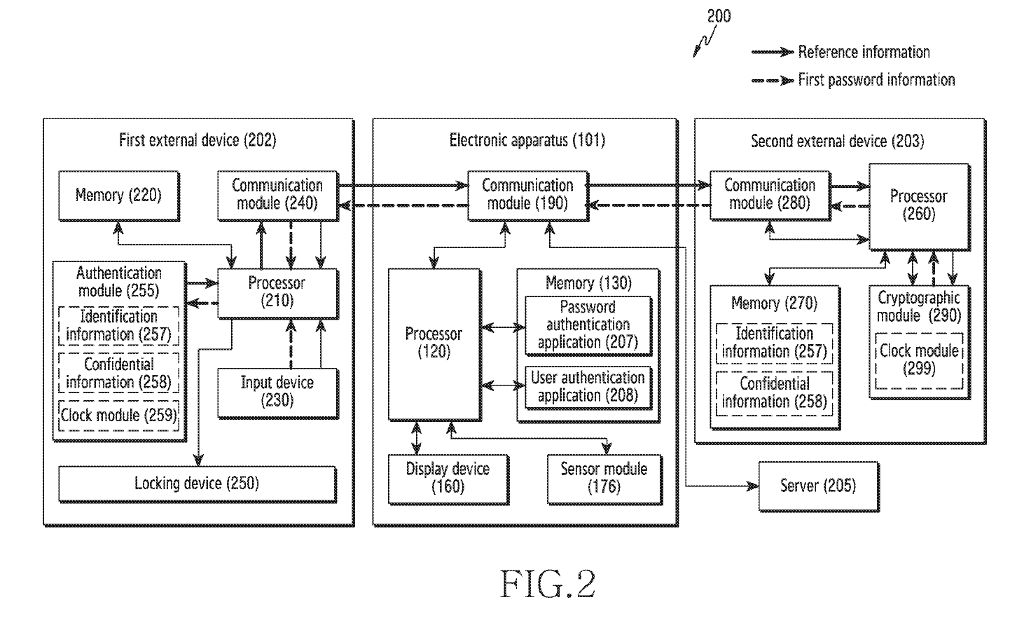

FIG. 2 illustrates a block diagram of a system 200 according to various embodiments.

Referring to FIG. 2, the system 200 may include an electronic apparatus 101, a first external device 202 (e.g., the electronic apparatus 102), and a second external device 203 (e.g., the electronic apparatus 104 and the server 108). The first external device 202 may be installed in a predetermined place. The first external device 202 may be provided for access or storage. The second external device 203 may manage an authentication module (e.g., an authentication module 255) attached to the first external device 202 and the first external device 202.

The first external device 202 may include a processor 210, a memory 220, an input device 230, a communication module 240, a locking device 250, or an authentication module 255. In some embodiments, some of these components may be omitted, or some of these components may be configured as a single integrated circuit.

The processor 210 may execute software to control at least one other component (e.g., a hardware or software component) of the first external device 202 connected to the processor 210 and may perform various types of data processing or operations. According to one embodiment, as at least part of the data processing or operations, the processor 210 may process a command or data received from another component (e.g., the communication module 240 or the authentication module 255) and may store the resulting data in the memory 220.

The memory 220 may store various data used by at least one component (e.g., the processor 210 or the authentication module 255) of the first external device 202. The data may include, for example, software and input data or output data about a command associated with the software.

The input device 230 may receive a command or data to be used for a component (e.g., the processor 210) of the first external device 202 from the outside (e.g., a user) of the first external device 202. The input device 230 may include, for example, a microphone, a mouse, or a keyboard.

The communication module 240 may support establishing a direct (e.g., wired) communication channel or a wireless communication channel between the first external device 202 and an electronic apparatus (the electronic apparatus 101) and performing communication through the established communication channel. The communication module 240 may include one or more communication processors that operate independently of the processor 120 and support direct (e.g., wired) communication or wireless communication. According to one embodiment, the communication module 240 may include a wireless communication module (e.g., a short-range wireless communication module) or a wired communication module (e.g., a LAN communication module or a power-line communication module). The wireless communication module may communicate with the electronic apparatus via a short-range wireless communication network (e.g., the first network 198, such as a short-range communication network including a Bluetooth, Wi-Fi direct, or IrDA network). These various types of communication modules may be integrated into one component (e.g., a single chip) or may be configured as a plurality of separate components (e.g., a plurality of chips). The wireless communication module may identify and authenticate the first external device 202 within a communication network, such as the short-range wireless communication network, using subscriber information (e.g., an International Mobile Subscriber Identity (IMSI)).

The locking device 250 may be used to open and close a predetermined space. For example, the locking device 250 may be installed in a door of a hotel room, an office, a house, a building or a vehicle, a luggage storage facility, a food trash can, a bicycle storage facility, a vending machine, or the like.

The authentication module 255 may generate password information on the basis of a predetermined seed value. The same seed value may be given to the first external device 202 and the second external device 203. For example, the seed value may include at least one of identification information 257 about the authentication module 255, confidential information 258 preset corresponding to the identification information 257, or time information detected by a clock module 259. To this end, the authentication module 255 may store the identification information 257 and the confidential information 258 and may include the clock module 259. The time information may be generated in synchronization with the first external device 202 and the second external device 203. The authentication module 255 may generate the password information, e.g., a one-time password (OTP), using the credential information 258 and the time information. The authentication module 255 may determine whether to control the locking device 250 on the basis of the password information. According to one embodiment, the authentication module 255 may be detachable from the first external device 202. The authentication module 255 may be detached from the first external device 202 and may be replaced.

The second external device 203 may include a processor 260, a memory 270, a communication module 280, and a cryptographic module 290. In some embodiments, some of these components may be omitted, or some of these components may be configured as a single integrated circuit.

The processor 260 may execute software to control at least one other component (e.g., a hardware or software component) of the second external device 203 connected to the processor 260 and may perform various types of data processing or operations. According to one embodiment, as at least part of the data processing or operations, the processor 260 may process a command or data received from another component (e.g., the communication module 280 or the cryptographic module 290) and may store the resulting data in the memory 270.

The memory 270 may store various data used by at least one component (e.g., the processor 260 or the cryptographic module 290) of the second external device 203. The data may include, for example, software and input data or output data about a command associated with the software. The memory 270 may store the identification information 257 about the authentication module 255 attached to the first external device 202 and the preset confidential information 258. The memory 270 may store the identification information 257 and the confidential information 258 in association with each other for each authentication module 255.

The communication module 280 may support establishing a direct (e.g., wired) communication channel or a wireless communication channel between the second external device 203 and an electronic apparatus (the electronic apparatus 101) and performing communication through the established communication channel. The communication module 280 may include one or more communication processors that operate independently of the processor 260 and support direct (e.g., wired) communication or wireless communication. According to one embodiment, the communication module 280 may include a wireless communication module (e.g., a cellular communication module, a short-range wireless communication module, or a GNSS communication module) or a wired communication module (e.g., a LAN communication module or a power-line communication module). The wireless communication module may communicate with the electronic apparatus via a short-range wireless communication network (e.g., the first network 198, such as a short-range communication network including a Bluetooth, Wi-Fi direct, or IrDA network) or a long-range wireless communication network (e.g., the second network 199, such as a long-range wireless communication network including a cellular network, the Internet, or a computer network (e.g., a LAN or WAN)). These various types of communication modules may be integrated into one component (e.g., a single chip) or may be configured as a plurality of separate components (e.g., a plurality of chips). The wireless communication module may identify and authenticate the second external device 203 within a communication network, such as the short-range wireless communication network or the long-range wireless communication network, using subscriber information (e.g., an International Mobile Subscriber Identity (IMSI)).

The cryptographic module 290 may produce password information that can be referred to by the first external device 202 on the basis of a predetermined seed value. The same seed value may be given to the first external device 202 and the second external device 203. For example, the seed value may include at least one of identification information 257 about the authentication module 255, confidential information 258 preset corresponding to the identification information 257, or time information detected by a clock module 299. To this end, the cryptographic module 290 may include the clock module 299. The time information may be generated in synchronization with the first external device 202 and the second external device 203. The cryptographic module 290 may generate the password information, e.g., a OTP, using the confidential information 258 corresponding to the identification information 257 about the first external device 202 and the time information.

According to various embodiments, the first external device 202 may provide the electronic apparatus 101 with reference information. To this end, the first external device 202 may store the reference information. The reference information may include at least one of the identification information 257 about the authentication module 255, ID information about the first external device 202, or payment information. The payment information may include a payment amount to be paid by the electronic apparatus 101 in response to the operation of the first external device 202. In one example, the processor 210 may transmit the reference information to the electronic apparatus 101 via the communication module 240. For example, the processor 210 may detect the access of the electronic apparatus 101 to the first external device 202 via the communication module 240 and may transmit the reference information to the electronic apparatus 101. The processor 210 may transmit the reference information to the electronic apparatus 101 in response to a request from the electronic apparatus 101. In another example, an identifier encoded with the reference information, such as a QR code or a bar code, may be attached to the first external device 202.

According to various embodiments, the electronic apparatus 101 may transmit the reference information to the second external device 203. The processor 120 may transmit the reference information to the second external device 203 via the communication module 190. The processor 120 may transmit the reference information to the second external device 203 on the basis of a password authentication application 207. According to one embodiment, the processor 120 may transmit the reference information to the second external device 203 on the basis of the user authentication result. To this end, the processor 120 may perform user authentication on the basis of a user authentication application 208. For example, the processor 120 may perform user authentication on the basis of biometric information detected using a sensor module 176. When user authentication is successful, the processor 120 may transmit the reference information to the second external device 203.

According to various embodiments, the second external device 203 may generate first password information on the basis of the reference information of the first external device 202. The processor 260 may receive the reference information of the first external device 202 from the electronic apparatus 101 via the communication module 280. The processor 260 may detect the confidential information 258 in response to the identification information 257 of the reference information. The cryptographic module 290 may generate the first password information using at least one of the confidential information 258, the time information detected by the time module 299, or the payment information among the reference information. The processor 260 may transmit the first password information to the electronic apparatus 101 via the communication module 280.

According to various embodiments, the electronic apparatus 101 may transmit the first password information to the first external device 202. The processor 120 may transmit the first password information to the first external device 202 via the communication module 190. The processor 120 may transmit the first password information to the first external device 202 on the basis of the password authentication application 207.

According to one embodiment, the processor 120 may transmit the first password information to the second external device 203 on the basis of the success of user authentication. To this end, the processor 120 may perform user authentication on the basis of the user authentication application 208. For example, the processor 120 may perform user authentication through a server 205 on the basis of biometric information detected using the sensor module 176. The server 205 may manage a user's right to control the first external device 202 and may respond to a request from the electronic apparatus 101. The user's right to control the first external device 201, managed on the server 205, may be set by an operator of the first external device 202. The user's right to control the first external device 202 may be set corresponding to a validity period. For example, when the first external device 202 is installed in a hotel room, the user's control right may be set corresponding to a reservation period for the hotel room. When the first external device 202 is installed in a vehicle, for example, a rental car, the user's control right may be set corresponding to a reservation period for the rental car. When the user authentication is successful, the processor 120 may transmit the first password information to the first external device 202.

According to another embodiment, the processor 120 may transmit the first password information to the second external device 203 on the basis of success of an electronic payment. To this end, the processor 120 may perform an electronic payment through the server 205. The server 205 may perform the electronic payment for the first external device 202 in response to the electronic apparatus, and may provide the result of the electronic payment to the electronic apparatus 101. When the electronic payment is successful, the processor 120 may transmit the first password information to the first external device 202.

According to various embodiments, the first external device 202 may perform locking control by comparing the first password information with second password information. In one example, the processor 210 may receive the first password information from the electronic apparatus via the communication module 240. In another example, the processor 210 may receive the first password information from a user of the electronic apparatus via the input device 230. The authentication module 250 may generate the second password information using at least one of the internal confidential information, time information, or payment information. At least one of the processor 210 or the authentication module 255 may compare the first password information with the second password information. When the first password information matches the second password information, the processor 210 or the authentication module 255 may control the locking device 250. Accordingly, the first external device 202 is able to open or close the predetermined space. For example, the first external device 202 may open the space, and may then close the space when a preset time elapses. When the space is opened, the first external device 202 may provide a stored article or product.

An electronic apparatus 101 according to various embodiments may include: a communication module 190; a display device 160; at least one processor 120 operatively connected to the communication module 190 and the display device 160; and a memory 130 operatively connected to the processor 120.

According to various embodiments, the memory 130 may store instructions that, when executed, enable the processor 120 to: transmit reference information, detected from a first external device 202, to a second external device 203 through the communication module 190; receive first password information, generated on the basis of the reference information, from the second external device 203 through the communication module 190; and provide the first password information to the first external device 202 through the communication module 190 so that the first external device 202 controls a locking device 250 on the basis of the first password information.

According to various embodiments, the instructions may enable the processor 120 to perform an electronic payment on the basis of the reference information upon receiving the first password information.

According to various embodiments, the instructions may enable the processor 120 to transmit the reference information to the second external device 203 when user authentication is successful.

According to various embodiments, the instructions may enable the processor 120 to provide the first password information to the first external device 202 when user authentication is successful.

According to various embodiments, the first external device 202 may be configured to include the locking device 250, configured to open and close a predetermined space, and an authentication module 255, configured to store identification information 257 about the first external device 202 and confidential information 258 set corresponding to the identification information 257, and to be detachable from the first external device 202.

According to various embodiments, the first external device 202 may be configured to generate second password information using the confidential information 258.

According to various embodiments, the first external device 202 may be configured to generate the second password information on the basis of the reference information, and to control the locking device 250 when the first password information matches the second password information.

According to various embodiments, the reference information may include at least one of identification information 257 about the first external device 202 and payment information.

According to various embodiments, the second external device 203 may be configured to store the identification information 257 and confidential information 258 in association with each other.

According to various embodiments, the second external device 203 may be configured to detect the confidential information 258 on the basis of the identification information 257 and to generate the first password information using the confidential information 258.

According to various embodiments, the instructions may enable the processor 120 to transmit the first password information to the first external device 202 through the communication module 190.

According to various embodiments, the instructions may enable the processor 120 to display the first password information on the display device 160.

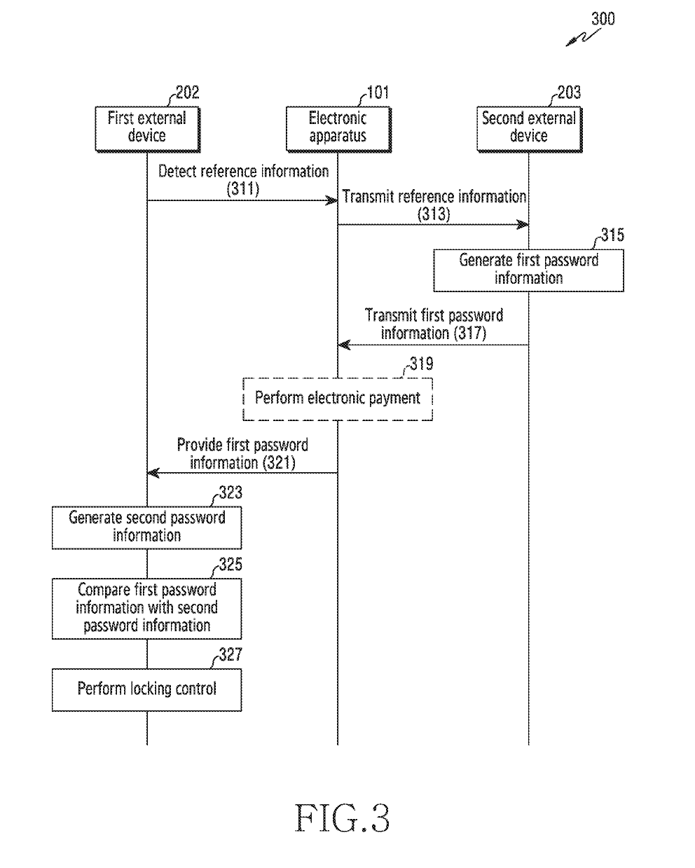

FIG. 3 illustrates a flowchart of an operating method 300 of an electronic apparatus 101 according to various embodiments.

Referring to FIG. 3, the electronic apparatus 101 may detect reference information of a first external device 202 in operation 311. In one example, the electronic apparatus 101 may receive at least part of the reference information from the first external device 202 by communicating with the first external device 202 through a short-range wireless communication network. In another example, the electronic apparatus 101 may detect at least part of the reference information by recognizing an identifier, such as a QR code or a bar code, attached to the first external device 202. In still another example, the electronic apparatus 101 may detect at least part of the reference information on the basis of a user input.

According to various embodiments, the first external device 202 may be installed at a predetermined place to open and close a predetermined space. The first external device 202 may be provided for access or storage. For example, the first external device 202 may be installed in a door of a hotel room, an office, a house, a building or a vehicle, a luggage storage facility, a food trash can, a bicycle storage facility, a vending machine, or the like. The reference information may include at least one of identification information 257, ID information, or payment information about the first external device 202. The identification information 257 may be identification information 257 about an authentication module 255 attached to the first external device 202. The payment information may include a payment amount to be paid by the electronic apparatus 101 in connection with the operation of the first external device 202.

The electronic apparatus 101 may transmit the reference information to the second external device 203 in operation 313. The electronic apparatus 101 may transmit the reference information to the second external device 203 via a long-range wireless communication network. According to one embodiment, the electronic apparatus 101 may transmit the reference information to a second external device 203 on the basis of the success of user authentication.

The second external device 203 may generate first password information in operation 315. The second external device 203 may generate the first password information on the basis of the reference information. The second external device 203 may store the identification information 257 of the first external device 202 and preset confidential information 258 in association with each other. The second external device 203 may identify the identification information 257 of the first external device 202 from the reference information and may detect the confidential information 258 corresponding to the identification information 257 of the first external device 202. The second external device 203 may detect time information. For example, the second external device 203 may detect the time information from the current time or the time when the reference information is received. Accordingly, the second external device 203 may generate the first password information using at least one of the confidential information 258, the time information, or the payment information among the reference information. For example, the second external device 203 may generate an OTP as the first password information.

The second external device 203 may transmit the first password information to the electronic apparatus 101 in operation 317. The second external device 203 may transmit the first password information to the electronic apparatus 101 via a long-range wireless communication network.

The electronic apparatus 101 may provide the first password information to the first external device 202 in operation 321. According to one embodiment, the electronic apparatus 101 may provide the first password information to the first external device 202 on the basis of the success of user authentication. According to another embodiment, the electronic apparatus 101 may perform an electronic payment in operation 319 and may then provide the first password information to the first external device 202 in operation 321. For example, the electronic apparatus 101 may perform an electronic payment on the basis of the success of user authentication in operation 319. The electronic apparatus 101 may perform an electronic payment using the ID information and the payment information among the reference information. The electronic apparatus 101 may provide the first password information to the first external device 202 upon the success of the electronic payment. For example, the electronic apparatus 101 may transmit the first password information to the first external device 202 by communicating with the first external device 202 via a short-range wireless communication network. In another example, the electronic apparatus 101 may display the first password information to guide a user to input the first password information to the first external device 202.

The first external device 202 may generate second password information in operation 323. The first external device 202 may generate the second password information on the basis of the reference information. In the first external device 202, the authentication module 255 may store the identification information 257 and the confidential information 258 preset corresponding to the identification information 257. The authentication module 255 may detect time information. For example, the first external device 202 may detect, as the time information, time points between the time the reference information is transmitted and the time the first password information is received or time points in a predetermined period from the time the first password information is received, for example, in a period of one minute before the time the first password information is received. Accordingly, the first external device 202 may generate the second password information using at least one of the confidential information 258, the time information, or the payment information among the reference information. For example, the first external device 202 may generate at least one OTP as the second password information. When the time information includes a plurality of time points, the first external device 202 may generate a plurality of OTPs.

The first external device 202 may compare the first password information with the second password information in operation 325. The first external device 202 may determine whether the first password information matches the second password information. For example, the first external device 202 may determine whether the OTP of the first password information matches one of the OTPs of the second password information.

The first external device 202 may perform locking control in operation 327. When the first password information matches the second password information, the first external device 202 may perform locking control. For example, when the OTP of the first password information matches one of the OTPs of the second password information, the first external device 202 may perform locking control. The first external device 202 may open or close the predetermined space. For example, the first external device 202 may open the space, and may then close the space when a preset time elapses. When the space is opened, the first external device 202 may provide a stored article or product.

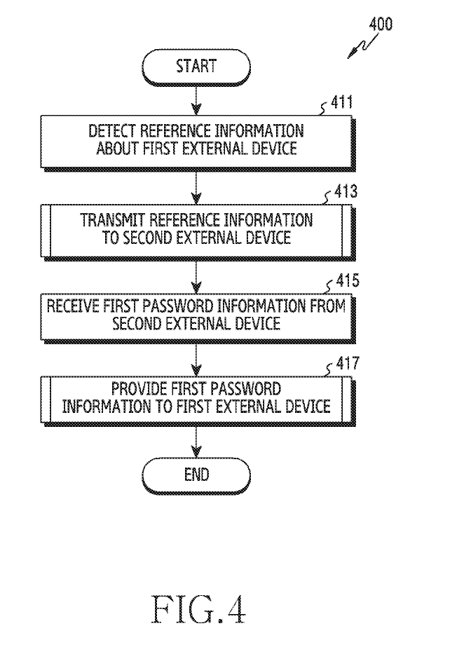

FIG. 4 illustrates a flowchart of an operating method 400 of an electronic apparatus 101 according to various embodiments.

Referring to FIG. 4, the electronic apparatus 101 may detect reference information of a first external device 202 in operation 411. In the electronic apparatus 101, a processor 120 may detect the reference information of the first external device 202. In one example, the processor 120 may receive at least part of the reference information from the first external device 202 via a communication module 190. To this end, the communication module 190 may communicate with the first external device 202 via a short-range wireless communication network. In another example, the processor 120 may detect at least part of the reference information by recognizing an identifier, such as a QR code or a bar code, attached to the first external device 202 via a camera module 180. In still another example, the processor 120 may detect a user input via an input device 150 and may detect at least part of the reference information from the user input.

The electronic apparatus 101 may transmit the reference information to a second external device 203 in operation 413. In the electronic apparatus 101, the processor 120 may transmit the reference information to the second external device 203. The processor 120 may transmit the reference information to the second external device 203 via the communication module 190. To this end, the communication module 190 may communicate with the second external device 203 via a long-range wireless communication network.

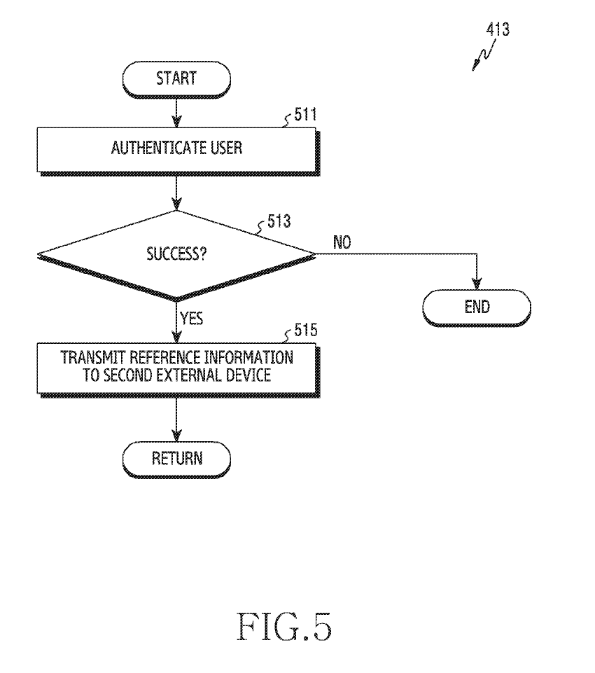

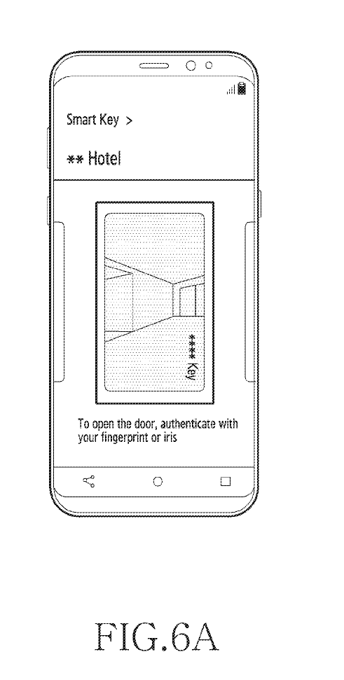

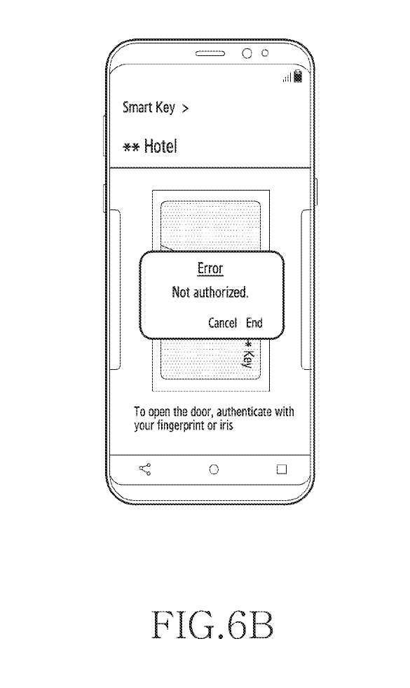

FIG. 5 illustrates a flowchart of an embodiment of the reference information transmission operation 413 in FIG. 4. FIG. 6A illustrates a graphical user interface displayed when the embodiment of the reference information transmission operation 413 in FIG. 4 is performed, and FIG. 6B illustrates a graphical user interface displayed when the embodiment of the reference information transmission operation 413 in FIG. 4 is performed.

Referring to FIG. 5, the electronic apparatus 101 may perform user authentication in operation 511. As illustrated in FIG. 6A, the processor 120 may display a Graphical User Interface (GUI) associated with user authentication through a display device, for example, display device 160 in FIG. 1. For example, the processor may require user authentication while displaying an electronic key for the first external device 202 in an inactive state on the GUI. The processor 120 may detect authentication information about a user, such as biometric information, for example, fingerprint information and iris information, through a sensor module 176. Further, the processor 120 may detect authentication information about the user, such as a password or a pattern, through an input device 150. Accordingly, the processor may perform user authentication on the basis of the authentication information about the user.

The electronic apparatus 101 may determine whether the user authentication is successful in operation 513. In the electronic apparatus 101, the processor 120 may determine whether the user authentication is successful. For example, the processor 120 may identify the user's control right. The processor 120 may request the user's right to control the first external device 202 from the server 205 through the communication module 190. To this end, the processor 120 may transmit, for example, at least one of the identification information 257 of the user or the authentication information to the server 205. The server 205 may manage the user's right to control the first external device 202 and may respond to a request from the electronic apparatus 101. The user's right to control the first external device 202 at the server 205 may be set by an operator of the first external device 202. The user's right to control the first external device 202 may be set corresponding to a validity period. For example, when the first external device 202 is installed in a hotel room, the user's control right may be set corresponding to a reservation period for the hotel room. When the first external device 202 is installed in a vehicle, for example, a rental car, the user's control right may be set corresponding to a reservation period for the rental car. To this end, the communication module 190 may communicate with the server 205 via a long-range wireless communication network.

When it is determined that the user authentication is successful in operation 513, the electronic apparatus 101 may transmit the reference information to the second external device 203 in operation 515. For example, when it is determined that the user has the right to control the first external device 202, the processor 120 may transmit the reference information to the second external device 203. Then, the electronic apparatus 101 may return to FIG. 4.

When it is determined that the user authentication fails in operation 513, the electronic apparatus 101 may not transmit the reference information to the second external device 203. For example, when it is determined that the user has no right to control the first external device 202, the processor 120 may not transmit the reference information to the second external device 203. The processor 120 may display a GUI to indicate an error on the display device, for example, display device 160 in FIG. 1, as illustrated in FIG. 6B. For example, the processor 120 may indicate the error while maintaining the electronic key for the first external device 202 in the inactive state on the GUI. Also, the processor 120 may output an audio signal to indicate the error via an audio module 170.

The electronic apparatus 101 may receive first password information from the second external device 203 in operation 415. In the electronic apparatus 101, the processor 120 may receive the first password information from the second external device 203. The processor 120 may receive the first password information from the second external device 203 via the communication module 190. To this end, the communication module 190 may communicate with the second external device 203 via a long-range wireless communication network.

The electronic apparatus 101 may provide the first password information to the first external device 202 in operation 417. In the electronic apparatus 101, the processor 120 may provide the first password information to the first external device 202. In one example, the processor 120 may transmit the first password information to the first external device 202 via the communication module 190. To this end, the communication module 190 may communicate with the first external device 202 via a short-range wireless communication network. In another example, the processor 120 may display the first password information on the display device 160. Accordingly, the processor 120 may guide the user to input the first password information to the first external device 202.

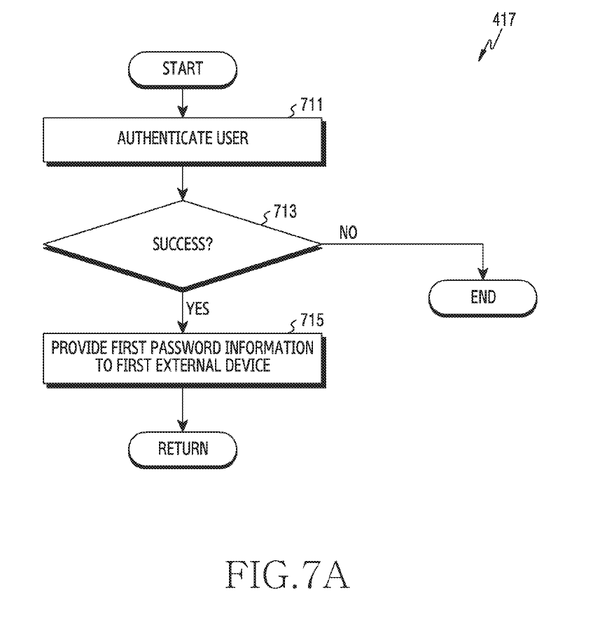

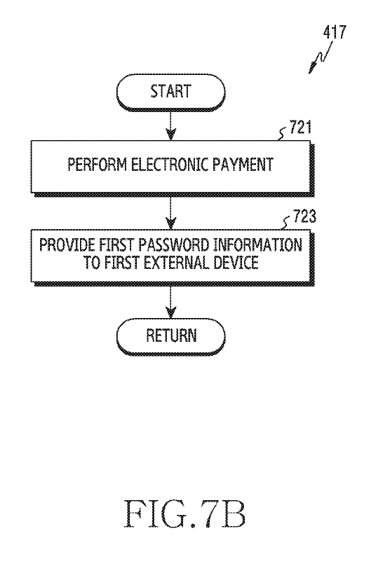

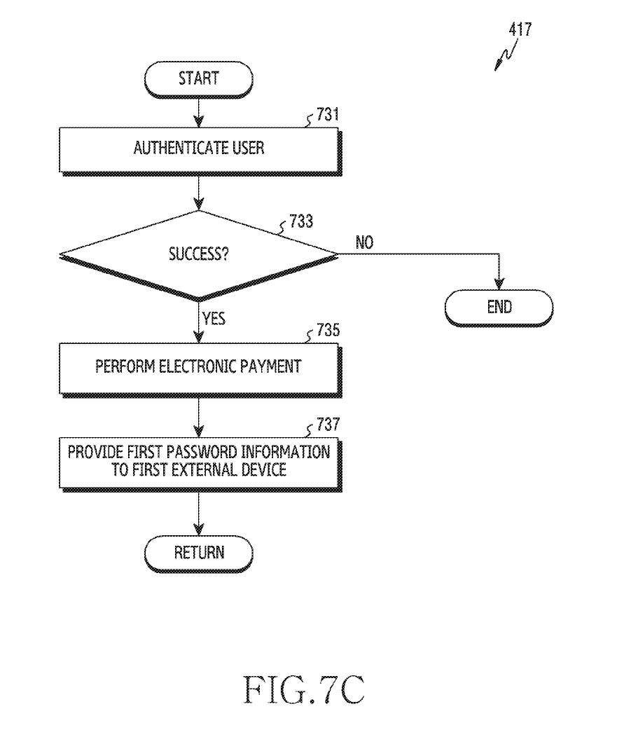

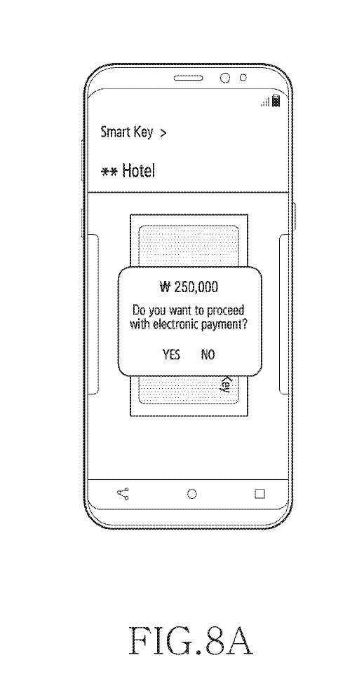

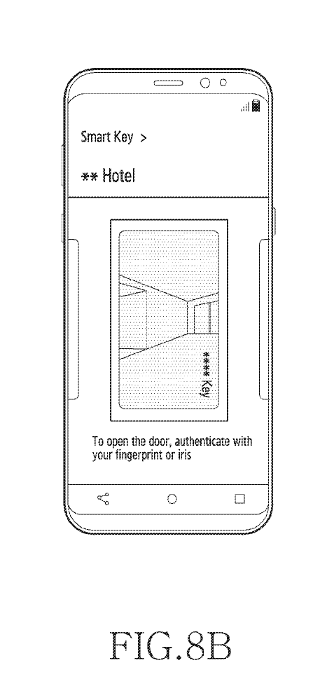

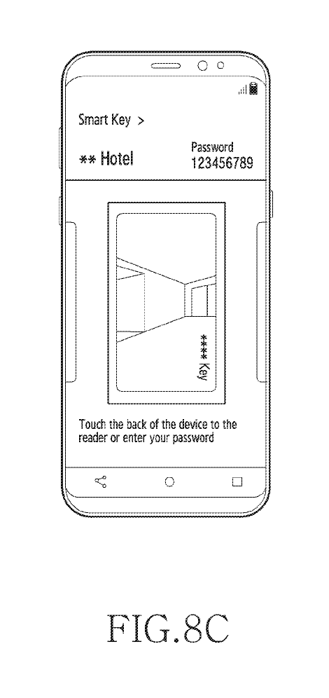

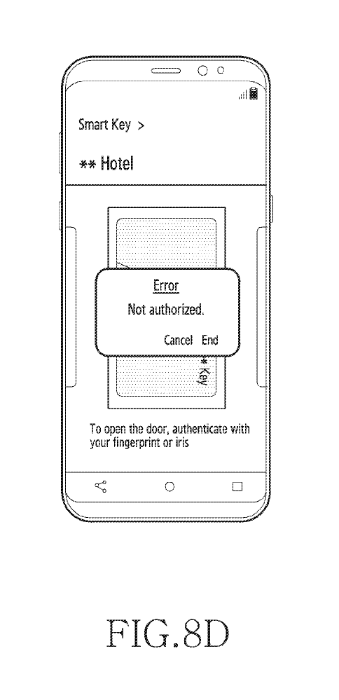

FIG. 7A illustrates a flowchart of an embodiment of the first password information transmission operation 417 in FIG. 4. FIG. 8A illustrates a GUI displayed when the embodiment of the first password information transmission operation 417 in FIG. 4 is performed, FIG. 8C illustrates a GUI displayed when the embodiment of the first password information transmission operation 417 in FIG. 4 is performed, and FIG. 8D illustrates a GUI displayed when the embodiment of the first password information transmission operation 417 in FIG. 4 is performed.

Referring to FIG. 7A, the electronic apparatus 101 may perform user authentication in operation 711. As illustrated in FIG. 8A, the processor 120 may display a GUI associated with user authentication through the display device, for example, display device 160 in FIG. 1. For example, the processor 120 may require user authentication while displaying an electronic key for the first external device 202 in an inactive state on the GUI. The processor 120 may detect authentication information about a user, such as biometric information, for example, fingerprint information and iris information, through the sensor module 176. Further, the processor 120 may detect authentication information about the user, such as a password or a pattern, through the input device 150. Accordingly, the processor 120 may perform user authentication on the basis of the authentication information about the user.

The electronic apparatus 101 may determine whether the user authentication is successful in operation 713. In the electronic apparatus 101, the processor 120 may determine whether the user authentication is successful. For example, the processor 120 may identify the user's control right. The processor 120 may request permission for the user's right to control the first external device 202 from the server 205 through the communication module 190. To this end, the processor 120 may transmit, for example, at least one of the identification information of the user or the authentication information to the server 205. The server 205 may manage the user's right to control the first external device 202 and may respond to a request from the electronic apparatus 101. The user's right to control the first external device 202 at the server 205 may be set by an operator of the first external device 202. The user's right to control the first external device 202 may be set corresponding to a validity period. For example, when the first external device 202 is installed in a hotel room, the user's control right may be set corresponding to a reservation period for the hotel room. When the first external device 202 is installed in a vehicle, for example, a rental car, the user's control right may be set corresponding to a reservation period for the rental car. To this end, the communication module 190 may communicate with the server via a long-range wireless communication network.

When it is determined that the user authentication is successful in operation 713, the electronic apparatus 101 may transmit the first password information to the first external device 202 in operation 715. For example, when it is determined that the user has the right to control the first external device 202, the processor 120 may transmit the first password information to the first external device 202. To this end, as illustrated in FIG. 8C, the processor 120 may display a GUI associated with the first password information on the display device, for example, display device 160 in FIG. 1. The processor 120 may guide the user on an operation to perform in order to provide the first password information to the first external device 202 via the GUI. For example, the processor 120 may guide the user on the operation by displaying the electronic key for the first external device 202 in the active state on the GUI. The processor 120 may display the first password information via a GUI. After displaying the GUI, the processor 120 may provide the first password information to the first external device 202 on the basis of the user's operation. In one example, the processor 120 may detect the access of the electronic apparatus 101 to the first external device 202 via the communication module 190 and may transmit the first password information to the first external device 202. In another example, the user may enter the first password information into the first external device 202. Then, the electronic apparatus 101 may return to FIG. 4.

According to one embodiment, after providing the first password information to the first external device 202, the electronic apparatus 101 may detect the occurrence of an error in the first external device 202. The processor may detect the occurrence of the error in the first external device 202 through the communication module 190. For example, as illustrated in FIG. 8D, the processor 120 may display a GUI to indicate the error on the display device, for example, display device 160 in FIG. 1. For example, the processor 120 may indicate the error while maintaining the electronic key for the first external device 202 in the inactive state on the GUI. Also, the processor 120 may output an audio signal to indicate an error via the audio module 170.

When it is determined that the user authentication fails in operation 713, the electronic apparatus 101 may not provide the first password information to the first external device 202. For example, when it is determined that the user has no right to control the first external device 202, the processor 120 may not provide the first password information to the first external device 202. The processor 120 may display a GUI to indicate an error on the display device 160, as illustrated in FIG. 8D. For example, the processor 120 may indicate the error while maintaining the electronic key for the first external device 202 in the inactive state on the GUI. Also, the processor 120 may output an audio signal to indicate the error via the audio module 170.

FIG. 7B illustrates a flowchart of another embodiment of the first password information transmission operation 417 in FIG. 4. FIG. 8B illustrates a GUI that is displayed when the embodiment of the first password information transmission operation 417 in FIG. 4 is performed, FIG. 8C illustrates a GUI that is displayed when the embodiment of the first password information transmission operation 417 in FIG. 4 is performed, and FIG. 8D illustrates a GUI that is displayed when the embodiment of the first password information transmission operation 417 in FIG. 4 is performed.

Referring to FIG. 7B, the electronic apparatus 101 may perform an electronic payment in operation 721. The processor 120 may perform the electronic payment using ID information and payment information among the reference information. As illustrated in FIG. 8B, the processor 120 may display a notification associated with the electronic payment on the display device, for example, display device 160 in FIG. 1. For example, the processor 120 may display the payment information among the reference information as a notification. The processor 120 may display a GUI associated with the electronic payment on the basis of a request from the user. For example, the processor 120 may transmit a request for the electronic payment relating to the first external device 202 to the server 205 via a communication module (e.g., 190). To this end, the processor 120 may transmit the ID information and the payment information among the reference information to the server 205. The server 205 may perform the electronic payment relating to the first external device 202 in response to the electronic apparatus 101, and may provide the result of the electronic payment to the electronic apparatus 101. To this end, the communication module 190 may communicate with the server 205 via a long-range wireless communication network.

The electronic apparatus 101 may provide the first password information to the first external device 202 in operation 723. For example, as illustrated in FIG. 8C, the processor 120 may display a GUI associated with the first password information on the display device 160. The processor 120 may guide the user on an operation to perform in order to provide the first password information to the first external device 202 via the GUI. For example, the processor 120 may guide the user on the operation by displaying the electronic key for the first external device 202 in the active state on the GUI. The processor 120 may display the first password information via a GUI. After displaying the GUI, the processor 120 may provide the first password information to the first external device 202 on the basis of the user's operation. In one example, the processor 120 may detect the access of the electronic apparatus 101 to the first external device 202 via the communication module 190 and may transmit the first password information to the first external device 202. In another example, the user may enter the first password information into the first external device 202. Then, the electronic apparatus 101 may return to FIG. 4.

According to one embodiment, after providing the first password information to the first external device 202, the electronic apparatus 101 may detect the occurrence of an error in the first external device 202. The processor 120 may detect the occurrence of the error in the first external device 202 through the communication module 190. Accordingly, as illustrated in FIG. 8D, the processor 120 may display a GUI to indicate the error on the display device 160. For example, the processor 120 may indicate the error while maintaining the electronic key for the first external device 202 in the inactive state on the GUI. Also, the processor 120 may output an audio signal to indicate an error via the audio module 170.

FIG. 7C illustrates a flowchart of another embodiment of the first password information transmission operation 417 in FIG. 4. FIG. 8A illustrates a GUI that is displayed when the embodiment of the first password information transmission operation 417 in FIG. 4 is performed, FIG. 8B illustrates a GUI that is displayed when the embodiment of the first password information transmission operation 417 in FIG. 4 is performed, FIG. 8C illustrates a GUI that is displayed when the embodiment of the first password information transmission operation 417 in FIG. 4 is performed, and FIG. 8D illustrates a GUI that is displayed when the embodiment of the first password information transmission operation 417 in FIG. 4 is performed.

Referring to FIG. 7C, the electronic apparatus 101 may perform user authentication in operation 731. As illustrated in FIG. 8A, the processor 120 may display a GUI associated with user authentication through the display device 160. For example, the processor 120 may require user authentication while displaying an electronic key for the first external device 202 in an inactive state on the GUI. The processor 120 may detect authentication information about a user, such as biometric information, for example, fingerprint information and iris information, through the sensor module 176. Further, the processor 120 may detect authentication information about the user, such as a password or a pattern, through the input device 150. Accordingly, the processor 120 may perform user authentication on the basis of the authentication information about the user.

The electronic apparatus 101 may determine whether the user authentication is successful in operation 733. In the electronic apparatus 101, the processor 120 may determine whether the user authentication is successful. For example, the processor 120 may identify the user's control right. The processor 120 may request the user's right to control the first external device 202 from the server 205 through the communication module 190. To this end, the processor 120 may transmit, for example, at least one of the identification information of the user or the authentication information to the server 205. The server 205 may manage the user's right to control the first external device 202, and may respond to a request from the electronic apparatus 101. The user's right to control the first external device 202 at the server 205 may be set by an operator of the first external device 202. To this end, the communication module 190 may communicate with the server 205 via a long-range wireless communication network.

When it is determined that the user authentication is successful in operation 733, the electronic apparatus 101 may perform an electronic payment in operation 735. The processor 120 may perform the electronic payment using ID information and payment information among the reference information. As illustrated in FIG. 8B, the processor 120 may display a notification associated with the electronic payment on the display device 160. For example, the processor 120 may display the payment information among the reference information as a notification. The processor 120 may display a GUI associated with the electronic payment on the basis of a request from the user. For example, the processor 120 may transmit a request for the electronic payment relating to the first external device 202 to the server 205 via the communication module 190. To this end, the processor 120 may transmit the ID information and the payment information among the reference information to the server 205. The server 205 may perform the electronic payment relating to the first external device 202 in response to the electronic apparatus 101 and may provide the result of the electronic payment to the electronic apparatus 101. To this end, the communication module 190 may communicate with the server 205 via a long-range wireless communication network.

The electronic apparatus 101 may provide the first password information to the first external device 202 in operation 737. For example, as illustrated in FIG. 8C, the processor 120 may display a GUI associated with the first password information on the display device 160. The processor 120 may guide the user on an operation to perform in order to provide the first password information to the first external device 202 via the GUI. For example, the processor 120 may guide the user on the operation by displaying the electronic key for the first external device 202 in the active state on the GUI. The processor 120 may display the first password information via a GUI. After displaying the GUI, the processor 120 may provide the first password information to the first external device 202 on the basis of the user's operation. In one example, the processor 120 may detect the access of the electronic apparatus 101 to the first external device 202 via the communication module 190 and may transmit the first password information to the first external device 202. In another example, the user may enter the first password information into the first external device 202. Then, the electronic apparatus 101 may return to FIG. 4.

According to one embodiment, after providing the first password information to the first external device 202, the electronic apparatus 101 may detect the occurrence of an error in the first external device 202. The processor 120 may detect the occurrence of the error in the first external device 202 through the communication module 190. Accordingly, as illustrated in FIG. 8D, the processor 120 may display a GUI to indicate the error on the display device 160. Also, the processor 120 may output an audio signal to indicate the error via the audio module 170.

When it is determined that the user authentication fails in operation 733, the electronic apparatus 101 may not provide the first password information to the first external device 202. For example, when it is determined that the user has no right to control the first external device 202, the processor 120 may not provide the first password information to the first external device 202. The processor 120 may display a GUI to indicate an error on the display device 160, as illustrated in FIG. 8D. For example, the processor 120 may indicate the error while maintaining the electronic key for the first external device 202 in the inactive state on the GUI. Also, the processor 120 may output an audio signal to indicate the error via the audio module 170.

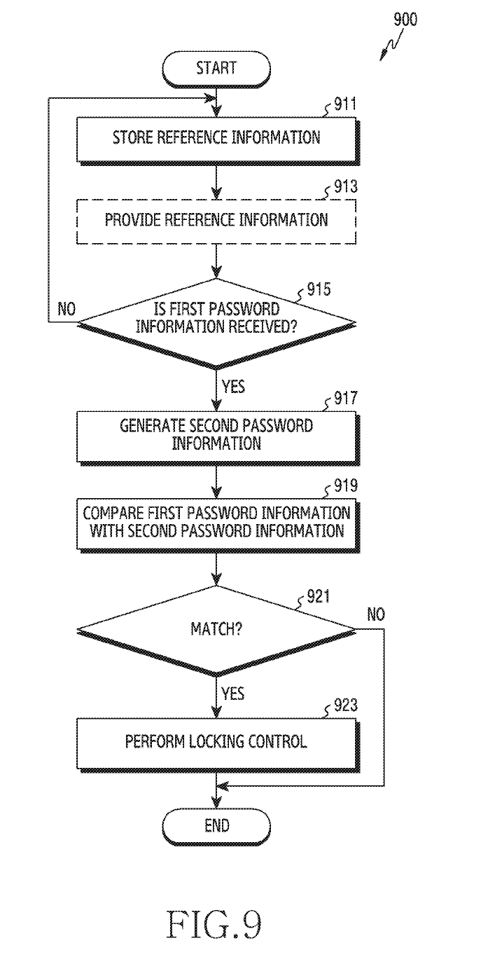

FIG. 9 illustrates a flowchart of an operating method 900 of a first external device 202 according to various embodiments.

Referring to FIG. 9, the first external device 202 may store reference information in operation 911. In the first external device 202, an authentication module 255 may store at least part of the reference information. The authentication module 255 may store identification information 257 about the authentication module 255 and confidential information 258 preset corresponding to the identification information 257. The authentication module 255 may include a clock module 259. The clock module 259 may operate in synchronization with a second external device 203. The reference information may include at least one of the identification information 257 about the authentication module 255, ID information about the first external device, or payment information. For example, in the first external device 202, a processor 210 may determine payment information about an article, a product, or a service required by the user of the electronic apparatus 101 in connection with the first external device 202. For example, in the first external device 202, a processor 210 may determine payment information about an article, a product, or a service required by the user of the electronic apparatus 101 in response to the first external device 202.

According to one embodiment, the first external device 202 may provide the reference information to the electronic apparatus 101 in operation 913. In the first external device 202, the processor 210 may provide the reference information to the electronic apparatus 101. The processor 210 may transmit the reference information to the electronic apparatus 101 via a communication module 240. To this end, the communication module 240 may communicate with the electronic apparatus 101 via a short-range wireless communication network. For example, the processor 210 may detect the access of the electronic apparatus 101 to the first external device 202 via the communication module 240 and may transmit the reference information to the electronic apparatus 101. The processor 210 may transmit the reference information to the electronic apparatus 101 in response to a request from the electronic apparatus 101.

The first external device 202 may receive first password information in operation 915. In the first external device 202, the processor 210 may receive the first password information. In one example, the processor 210 may receive the first password information via the communication module 240. To this end, the communication module 240 may communicate with the electronic apparatus 101 via a short-range wireless communication network. In another example, the processor 210 may receive a user input via an input device 230 and may detect the first password information from the user input. For example, the first password information may be an OTP. The processor 210 may transmit the first password information to the authentication module 259.

The first external device 202 may generate second password information in operation 917. In the first external device 202, the authentication module 255 may generate the second password information. The authentication module 255 may generate the second password information on the basis of the reference information. The authentication module 255 may generate the second password information using at least one of the confidential information 258, time information, or payment information. The authentication module 255 may detect the time information from the clock module 259. For example, the authentication module 255 may detect, as the time information, time points between the time the reference information is transmitted and the time the first password information is received or time points in a predetermined period from the time the first password information is received, for example, in a period of one minute before the time the first password information is received. The authentication module 255 may generate, for example, at least one OTP as the second password information. When the time information includes a plurality of time points, the authentication module 255 may generate a plurality of OTPs.

The first external device 202 may compare the first password information with the second password information in operation 919. In the first external device 202, the authentication module 255 may compare the first password information with the second password information. The first external device 202 may determine whether the first password information matches the second password information in operation 921. In the first external device 202, the authentication module 255 may determine whether the first password information matches the second password information. For example, the authentication module 255 may determine whether the OTP of the first password information matches one of the OTPs of the second password information.

When it is determined that the first password information matches the second password information in operation 921, the first external device 202 may perform locking control in operation 923. For example, when the OTP of the first password information matches one of the OTPs of the second password information, the first external device 202 may perform locking control. In one example, in the first external device 202, the authentication module 255 may perform locking control of the locking device 250. In another example, in the first external device 202, the processor 210 may identify from the authentication module 255 whether the first password information matches the second password information and may perform locking control of the locking device 250. For example, the locking device 250 may be unlocked. Accordingly, the first external device 202 may open or close a predetermined space. For example, the first external device 202 may open the space, and may then close the space when a preset time elapses. When the space is opened, the first external device 202 may provide a stored article or product.

When it is determined that the first password information does not match the second password information in operation 921, the first external device 202 may not perform locking control. For example, when the OTP of the first password information does not match the OTPs of the second password information, the first external device 202 may determine that an error has occurred and may not perform locking control. That is, in the first external device 202, the authentication module 255 or the processor 210 may maintain the current state of the locking device 250. According to one embodiment, the processor 210 may notify the electronic apparatus 101 of the error via the communication module 240. To this end, the communication module 240 may communicate with the electronic apparatus 101 via a short-range wireless communication network. According to another embodiment, the processor 210 may generate an alarm to indicate the error as at least one of an audio signal or display data.

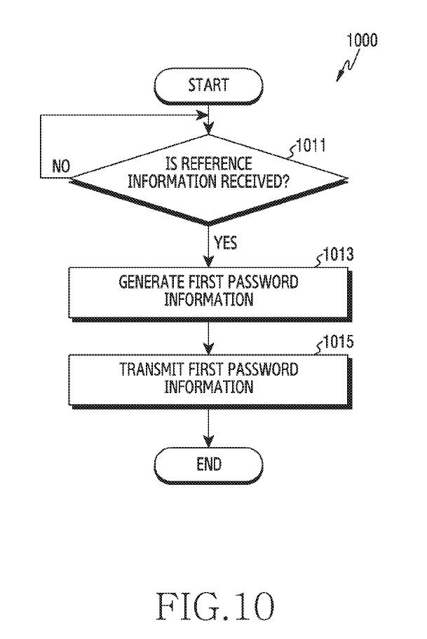

FIG. 10 is a flowchart illustrating an operating method 1000 of a second external device 203 according to various embodiments.

Referring to FIG. 10, the second external device 203 may receive reference information from an electronic apparatus 101 in operation 1011. In the second external device 203, a processor 260 may receive the reference information from the electronic apparatus 101. The processor 260 may receive the reference information from the electronic apparatus 101 via a communication module 280. To this end, the communication module 280 may communicate with the electronic apparatus 101 via a long-range wireless communication network. The reference information may include at least one of identification information 257 about an authentication module 255 of a first external device 202, ID information about the first external device 202, or payment information.

The second external device 203 may generate first password information in operation 1013. In the second external device, the processor 260 may generate the first password information. The processor 260 may generate the first password information on the basis of the reference information. In the second external device 203, a memory 270 may store the identification information 257 about the authentication module 255 of the first external device 202 and preset confidential information 258 in association with each other. The second external device 203 may include a clock module 299. The clock module 299 may operate in synchronization with the authentication module 255 of the first external device 202. The processor 260 may detect the confidential information 258 corresponding to the identification information 257 of the reference information. The processor 260 may generate the first password information using at least one of the confidential information 258, time information, or the payment information among the reference information. The processor 260 may detect the time information from the clock module 299. For example, the processor 260 may detect the time information from the current time or the time when the reference information is received. The processor 260 may generate, for example, an OTP as the first password information.

The second external device 203 may transmit the first password information to the electronic apparatus 101 in operation 1015. In the second external device 203, the processor 260 may transmit the first password information to the electronic apparatus 101. The processor 260 may transmit the first password information to the electronic apparatus 101 via the communication module 280. To this end, the communication module 280 may communicate with the electronic apparatus 101 via a long-range wireless communication network.

An operating method of an electronic apparatus 101 according to various embodiments may include: an operation of transmitting reference information, detected from a first external device 202, to a second external device 203; an operation of receiving first password information, generated on the basis of the reference information, from the second external device 203; and an operation of providing the first password information to the first external device 202 so that the first external device 202 controls a locking device 250 on the basis of the first password information.

According to various embodiments, the operating method of the electronic apparatus 101 may further include an operation of performing an electronic payment on the basis of payment information among the reference information upon receiving the first password information.

According to various embodiments, the operation of transmitting the reference information may include an operation of transmitting the reference information to the second external device 203 when user authentication is successful.

According to various embodiments, the operation of providing the first password information may include an operation of providing the first password information to the first external device 202 when user authentication is successful.

According to various embodiments, the first external device 202 may be configured to generate the second password information on the basis of the reference information, and to control the locking device 250 when the first password information matches the second password information.

According to various embodiments, the reference information may include at least one of identification information 257 about the first external device 202 and payment information.

According to various embodiments, the operation of providing the first password information may include at least one of an operation of displaying the first password information or an operation of transmitting the first password information to the first external device 202.

According to various embodiments, a non-transitory computer-readable storage medium may store one or more programs to implement: an operation of transmitting reference information, detected from a first external device 202, to a second external device 203; an operation of receiving first password information, generated on the basis of the reference information, from the second external device 203; and an operation of providing the first password information to the first external device 202 so that the first external device 202 controls a locking device 250 on the basis of the first password information.

According to various embodiments, the programs may further implement an operation of performing an electronic payment on the basis of payment information among the reference information upon receiving the first password information.

According to various embodiments, the operation of transmitting the reference information may include an operation of transmitting the reference information to the second external device 203 when user authentication is successful.

According to various embodiments, the first external device 202 may be configured to generate the second password information on the basis of the reference information, and to control the locking device 250 when the first password information matches the second password information.

According to various embodiments, because the electronic apparatus 101 transmits required information, for example, the reference information of the first external device 202 and the first password information of the second external device 203, between the first external device 202 and the second external device 203, the user of the electronic apparatus 101 can use an unattended service through the first external device 202. Accordingly, even though the user of the electronic apparatus 101 does not register personal information, such as biometric information, in the first external device 202 or the second external device 203, the first external device 202 can authenticate the user. Further, even though the first external device 202 does not directly communicate with the second external device 203 via a network, the first external device 202 can authenticate the user. In addition, since the first external device 202 or the second external device 203 does not store the personal information of the user, such as biometric information, it is possible to prevent the leakage of the personal information of the user, such as biometric information.

An electronic device according to various embodiments disclosed herein may be various types of devices. The electronic device may, for example, include at least one of a portable communication device (e.g., smartphone) a computer device, a portable multimedia device, a portable medical device, a camera, a wearable device, and a home appliance. The electronic device according to embodiments of the disclosure is not limited to the above-described devices.

The various embodiments and the terms used herein are not intended to limit the technical features disclosed herein to specific embodiments, and should be understood to include various modifications, equivalents, and/or alternatives to the corresponding embodiments. In describing the drawings, similar reference numerals may be used to designate similar or relevant constituent elements. As used herein, the singular form of a noun corresponding to an item may include one item or a plurality of items unless the context clearly indicates otherwise. In this document, the expression “A or B”, “at least one of A and B”, “at least one of A or B”, “ A, B, or C”, “at least one of A, B, and C”, “at least one of A, B, or C”, or the like may include all possible combinations of the items listed in the expression. The expression “a first”, “a second”, “the first”, “the second”, or the like may be used merely to distinguish one element from another element and does not limit elements in different aspects (e.g., the order or the importance thereof). It should be understood that when an element (e.g., a first element) is referred to as being (operatively or communicatively) “coupled” or “connected” to another element (e.g., a second element), the element may be connected or coupled to the other element directly (e.g., in a wired manner), wirelessly, or via a third element.

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. According to an embodiment, for example, the module may be implemented in the form of an application-specific integrated circuit (ASIC).

Various embodiments disclosed herein may be implemented by software (e.g., program 140) including one or more instructions stored in a storage medium (e.g., internal memory 136 or external memory 138) readable by a machine (e.g., electronic device 101). For example, a processor (e.g., processor 120) of a machine (e.g., electronic device 101) may call at least one of the stored instructions from the storage medium and execute the same. This makes it possible to operate the machine such that the machine performs at least one function according to the at least one called instruction. The at least one instruction may include a code which is generated by a compiler or a code which can be executed by an interpreter. The machine-readable storage media may be provided in the form of non-transitory storage media. Here, the term “non-transitory” only means that the storage media is a tangible device and does not include a signal, regardless of whether data is semi-permanently or temporarily stored in the storage medium.

According to one embodiment, the methods according to various embodiments disclosed herein may be included and provided in a computer program product. A computer program product may be traded as a commodity between a seller and a purchaser. A computer program product may be distributed in the form of a machine-readable storage medium (e.g., Compact Disc Read Only Memory (CD-ROM)) or may be distributed online (e.g., downloaded or uploaded) via an app store (e.g., Play Store™) or directly between two user devices (e.g., smartphones). In the case of online distribution, at least a portion of the computer program product may be at least temporarily stored or provisionally generated in a machine-readable storage medium, such as a memory of a manufacturer server, an app store server, or a relay server.

According to various embodiments, each (e.g., module or program) of the foregoing components may include a single entity or a plurality of entities. According to various embodiments, one or more of the aforementioned components or operations may be omitted or one or more other components or operations may be further included. Alternatively or additionally, a plurality of components (e.g., modules or a programs) may be integrated into one component. In this case, the integrated component may perform one or more functions of each of the plurality of components equivalent or similar to those performed by the respective components before integration. According to various embodiments, operations performed by a module, a program, or other components may be carried out sequentially, in parallel, repeatedly, or heuristically, one or more of the operations may be carried out in a different order or may be omitted, or one or more other operations may be added.

According to various embodiments, because the electronic apparatus transmits required information between the first external device and the second external device, the user of the electronic apparatus can use an unattended service through the first external device. Accordingly, even though the user of the electronic apparatus does not register personal information, such as biometric information, in the first external device or the second external device, the first external device can authenticate the user. Further, even though the first external device does not directly communicate with the second external device via a network, the first external device can authenticate the user. In addition, since the first external device or the second external device does not store the personal information of the user, such as biometric information, it is possible to prevent the leakage of the personal information of the user, such as biometric information.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic apparatus comprising:
a communication module;
a display device;
at least one processor configured to be operatively connected to the communication module and the display device; and
a memory configured to be operatively connected to the processor,
wherein the memory stores instructions that, when executed by the processor, cause the processor to:
transmit reference information, detected from a first external device, to a second external device through the communication module;
receive first password information, generated based on the reference information, from the second external device through the communication module; and
provide the first password information to the first external device through the communication module so that the first external device controls a locking device based on the first password information.

2. The electronic apparatus of claim 1, wherein the instructions, when executed by the processor, further cause the processor to perform an electronic payment on a basis of the reference information upon receiving the first password information.

3. The electronic apparatus of claim 1, wherein the instructions, when executed by the processor, further cause the processor to transmit the reference information to the second external device when user authentication is successful.

4. The electronic apparatus of claim 1, wherein the instructions, when executed by the processor, further cause the processor to provide the first password information to the first external device when user authentication is successful.

5. The electronic apparatus of claim 1, wherein:
the first external device includes the locking device;
the locking device is configured to open and close a predetermined space;
the first external device further includes an authentication module;
the authentication module is configured to:
store identification information about the first external device and confidential information set corresponding to the identification information; and
be detachable from the first external device; and
the first external device is configured to generate second password information using the confidential information.

6. The electronic apparatus of claim 1, wherein the first external device is configured to:
generate second password information based on the reference information, and
control the locking device when the first password information matches the second password information.

7. The electronic apparatus of claim 6, wherein the reference information comprises at least one of identification information about the first external device or payment information.

8. The electronic apparatus of claim 7, wherein the second external device is configured to:
store the identification information and confidential information in association with each other,
detect the confidential information based on the identification information, and
generate the first password information using the confidential information.

9. The electronic apparatus of claim 1, wherein the instructions, when executed by the processor, further cause the processor to display the first password information on the display device.

10. An operating method of an electronic apparatus, the method comprising:
transmitting reference information, detected from a first external device, to a second external device;
receiving first password information, generated based on the reference information, from the second external device; and
providing the first password information to the first external device so that the first external device controls a locking device based on the first password information.

11. The method of claim 10, further comprising:
performing an electronic payment based on payment information among the reference information upon receiving the first password information.

12. The method of claim 10, wherein transmitting the reference information to the second external device comprises transmitting the reference information to the second external device when user authentication is successful.

13. The method of claim 10, wherein providing the first password information to the first external device comprises providing the first password information to the first external device when user authentication is successful.

14. The method of claim 10, wherein the first external device generates second password information based on the reference information and controls the locking device when the first password information matches the second password information.

15. The method of claim 14, wherein the reference information comprises at least one of identification information about the first external device or payment information.

16. The method of claim 10, wherein providing the first password information to the first external device comprises at least one of displaying the first password information or transmitting the first password information to the first external device.

17. A non-transitory computer-readable medium comprising instructions that, when executed by a processor, cause the processor to:
transmit reference information, detected from a first external device, to a second external device;
receive first password information, generated based on the reference information, from the second external device; and
provide the first password information to the first external device so that the first external device controls a locking device based on the first password information.

18. The non-transitory computer-readable medium of claim 17, wherein the instructions, when executed by the processor, further cause the processor to perform an electronic payment based on payment information among the reference information upon receiving the first password information.

19. The non-transitory computer-readable medium of claim 17, wherein the instructions that, when executed, cause the processor to transmit the reference information to the second external device comprise instructions that, when executed by the processor, further cause the processor to transmit the reference information to the second external device when user authentication is successful.

20. The non-transitory computer-readable medium of claim 17, wherein the first external device is configured to generate second password information based on the reference information, and control the locking device when the first password information matches the second password information.
